(19) United States
(12) Patent Application Publication
(10) Pub. No.: US 2014/0304008 A1
(43) Pub. Date: Oct. 9, 2014

(54) SYSTEM AND METHOD FOR AUTOMATED CLAIMS DATA AUDITING

(71) Applicant: Hartford Fire Insurance Company, (US)

(72) Inventors: J. Scott Dorris, Glastonbury, CT (US); Suzanne R. DeMarchi, Wellington, FL (US); Venkata Uma Lakkakula, Rocky Hill, CT (US); Vani Sundar, Newington, CT (US)

(73) Assignee: Hartford Fire Insurance Company, Hartford, CT (US)

(21) Appl. No.: 13/859,469

(22) Filed: Apr. 9, 2013

(51) Int. Cl. G06Q 40/08

(52) U.S. Cl. CPC G06Q 40/08
USPC 705/4

(57) ABSTRACT

A system and method for automated claims data auditing. The system may include a memory device configured to store a plurality of audit questions associated with audit question metadata, to store a plurality tasks associated with task metadata, to store a plurality workflows associated with workflow metadata and to store a plurality surveys associated with survey metadata. The system may include a processor configured to generate an audit template based on at least a subset of the plurality of surveys and the plurality of tasks. The processor may further be configured to generate a copy of the audit template for use in a project. The system may include a receiver configured to receive assignment instructions associated with the project, wherein the assignment instructions assign resources to the project. The receiver may further be configured to receive claim data to be audited, wherein the processor may be configured to integrate the received claim data, the copy of the audit template, and the assignment instructions to create the project. The system may also include a publishing module configured to publish the project.

### TECHNICAL FIELD

The subject matter disclosed herein relates to computer systems and data communication systems. More particularly, the subject matter disclosed herein related to the electronic storage, communication, processing, and display of data related to business insurance and other insurance products.

### BACKGROUND

Managing an insurance company claim servicing performance is essential to the health of the business. Claim auditing is an effective tool for managing claim servicing and evaluating the performance of claim adjusters and other employees. A claim audit measures the performance of a claim servicing professional against predetermined benchmarks or industry best practice statistics.

The claim auditing process may comprise a review of closed files and be performed by audit teams that are internal to the carrier or independent/third party auditors. For larger organizations, the claim auditing process may involve both internal and external auditors.

Managing audits may be a complex task. Internal auditor teams may be staffed by senior adjusters, each having developed their own set of auditing questions and forms. These internal auditors may then use a type of “scorecard” to provide a final score on the audit. An external auditing team may have developed their own separate auditing practice and may use their own scorecard to provide a final score on the audit. Since each internal auditing unit and each external auditing unit may use separate and distinct scorecards, they may produce results that are not normalized.

The business of an insurance company is to properly evaluate the risks being covered by a particular policy, and then ultimately evaluate and pay a claim against the policy in accordance with the terms of the policy that was purchased by the policy holder. The goal for an insurance company is to do this as efficiently as possible.

There are many different aspects of the insurance underwriting process that can greatly vary, and each of these aspects can have an effect on the ability to accurately assess the risks being covered. Auditing this process is a way to ensure that that the risk is being properly assessed, and the company's processes are being effectively implemented. Accordingly, methods are desired to normalize the auditing process and provide a method and system to evaluate the auditors.

### SUMMARY

A system and method for automated claims data auditing. The system may include a memory device configured to store a plurality of audit questions associated with audit question metadata, to store a plurality tasks associated with task metadata, to store a plurality workflows associated with workflow metadata and to store a plurality surveys associated with survey metadata. The system may include a processor configured to generate an audit template based on at least a subset of the plurality of surveys and the plurality of tasks. The processor may further be configured to generate a copy of the audit template for use in a project. The system may include a receiver configured to receive assignment instructions associated with the project, wherein the assignment instructions assign resources to the project. The receiver may further be configured to receive claim data to be audited, wherein the processor may be configured to integrate the received claim data, the copy of the audit template, and the assignment instructions to create the project. The system may also include a publishing module configured to publish the project.

### BRIEF DESCRIPTION OF THE DRAWINGS

A more detailed understanding may be had from the following description, given by way of example in conjunction with the accompanying drawings wherein:

FIG. 1 shows an example architecture for communicating, displaying, and processing data related to insurance products;

FIG. 2 shows a flow diagram for a method for automated claims data auditing;

FIG. 3 shows a functional block diagram of a system for automated claims data auditing;

FIG. 4 shows example web page to provide a user with access to the master question repository;

FIG. 5 shows example web page to provide a user with access to the survey builder;

FIG. 6 shows example web page to provide a user with access to the master task repository;

FIG. 7 shows example web page to provide a user with access to the workflow repository;

FIG. 8 shows example web page to provide a user with access to the audit template builder;

FIG. 9 shows example web page for providing access to the system administration module;

FIG. 10 shows example web page for accessing the project tracking module;

FIGS. 11A and 11B show an example web page to provide access to the project tracking module;

FIG. 12 shows example web page to provide access to the PMO oversight module;

FIG. 13 shows example web page to provide access to file review module;

FIGS. 14A and 14B show an example web page to provide access to the report card generator;

FIG. 15 shows an example computing device that may be used to implement features described herein with reference to FIGS. 1-14B; and

FIG. 16 shows an example cellular phone that may be used to implemented features described herein with reference to FIGS. 1-15.

### DETAILED DESCRIPTION

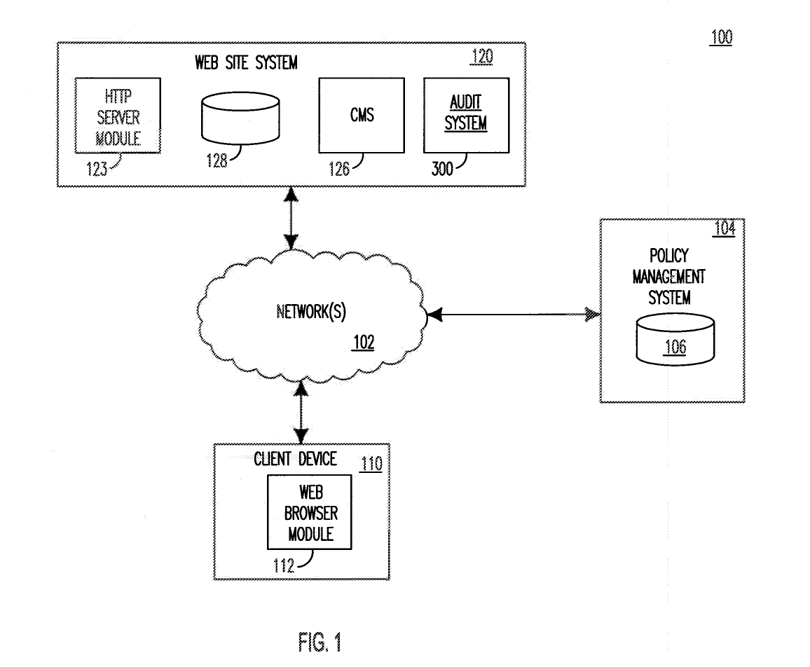

FIG. 1 shows example architecture 100 for communicating, displaying, and processing data related to insurance products. The example architecture 100 includes a web site system 120, and a user device 110, a policy management system 104, and one or more communication networks 102. The web site system 120 may provide access to a web site that is managed by an insurance company. The user device 110 may access the web site via the one or more communication networks 102, and display the web site to a user of the user device 110. The user may be, for example, a system administrator, a project owner, an internal auditor, or an external auditor.

Users may provide information that is responsive to questions, which may then be transmitted to the web site system 120 by the user device 110. The audit central system 300 may then determine, based on the information provided by the user in response to the questions, a report card for the auditor and the claims adjuster. The web site system 120 may then transmit additional information back to a user for evaluation of the claims servicing process.

The web site system 120 may include a HyperText Transfer Protocol (HTTP) server module 123, a Content Management System (CMS) 126, a web site database 128, and an audit central system 300. The HTTP server module 123 may implement the HTTP protocol, and may communicate HyperText Markup Language (HTML) pages and related data from the web site to/from the user device 110 using HTTP. The HTTP server module 123 may be, for example, an Apache HTTP server, a Sun-ONE Web Server, a Microsoft Internet Information Services (IIS) server, and/or may be based on any other appropriate HTTP server technology.

The web site database 128 may store information that describes and provides the content of the web site. The web site database 128 may be a relational database, a hierarchical database, an object-oriented database, one or more flat files, one or more spreadsheets, and/or one or more structured files. The web site database 128 may be managed by a database management system (not depicted) in the web site system 120, which may be based on a technology such as Microsoft SQL Server, MySQL, PostgreSQL, Oracle Relational Database Management System (RDBMS), a NoSQL database technology, and/or any other appropriate technology. In addition to the page that includes one or more questions that solicit information regarding the user's business, the web site may include one or more Electronic Books (E-Books) that provide information related to the business insurance products offered by the insurance company. Information describing the web pages and the E-Books that constitute the web site may be stored in the web site database 128.

The CMS 126 may be used by administrators of the web site to manage the content of the web site stored in the web site database 128. The CMS 126 may change the content of the web site by adding, deleting, or modifying data in the web site database 128 via the database management system. The CMS 126 may be, for example, a Fatwire system, a Drupal system, a Joomla system, an IBM Lotus Web Content Management system, and/or may be based on any other appropriate CMS technology.

As described above, the web site system 120 may transmit web pages to the user device 110 that may include one or more questions that solicit information regarding claim auditing. This may be performed by, for example, the HTTP server module 123 in conjunction with the CMS 126 and/or the web site database 128. Also as described above, the user may provide information that is responsive to the questions, which may then be transmitted to the web site system 120 by the user device 110. The information may be received via the HTTP server module 123, which may then provide the information to the audit central system 300.

The web site system 120 may also include one or more additional components or modules (not depicted), such as one or more load balancers, firewall devices, routers, switches, and devices that handle power backup and data redundancy.

The user device 110 may include a web browser module 112, which may communicate data related to the web site to/from the HTTP server module 123 in the web site system 120 via the one or more communication networks 102. The web browser module 112 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 112 may implement Rich Internet Application (RIA) and/or multimedia technologies such as Adobe Flash, Microsoft Silverlight, and/or other technologies. The web browser module 112 may implement RIA and/or multimedia technologies using one or web browser plug-in modules (such as, for example, an Adobe Flash or Microsoft Silverlight plugin), and/or using one or more sub-modules within the web browser module 112 itself. The web browser module 112 may display data on one or more display devices (not depicted) that are included in or connected to the user device 110, such as a liquid crystal display (LCD) display or monitor. The user device 110 may receive input from the user of the user device 110 from input devices (not depicted) that are included in or connected to the user device 110, such as a keyboard, a mouse, or a touch screen, and provide data that indicates the input to the web browser module 112. The user device 110 may be, for example, a cellular phone, a laptop computer, a tablet computer, or any other appropriate computing device.

The policy management system 104 may perform functionality such as managing information related to one or more insurance products held by the insurance company. The policy management system 104 may include a product management database 106, which may store information that describe clients of the insurance company and the policies products provided to the clients by the insurance company as well as claims received by the insurance company. The web site system 120 may also include the product management database 106. The product management database 106 may be a relational database, a hierarchical database, an object-oriented database, one or more flat files, one or more spreadsheets, and/or one or more structured files. The product management database 106 may be managed by a database management system (not depicted). When a client enters into an agreement for the purchase of a product with the insurance company, information related to the agreement may be added to the product management database 106.

The one or more communication networks 102 in the example architecture 100 may include one or more private Local Area Networks (LANs), and/or one or more public communication networks such as the Internet. The one or more communication networks 102 may be based on wired and/or wireless networking technologies.

The architecture 100 of FIG. 1 may be implemented using any number of different network topologies and computing devices. For example, each of the quoting/binding module 122, HTTP server module 123, CMS 126, and audit central system 300 may be implemented using a single computing device, as one or more separate computing devices, or spread across any two or more computing devices, in any combination. Further, the policy management system 104 may be implemented using a single computing device, as one or more separate computing devices, or spread across any two or more computing devices.

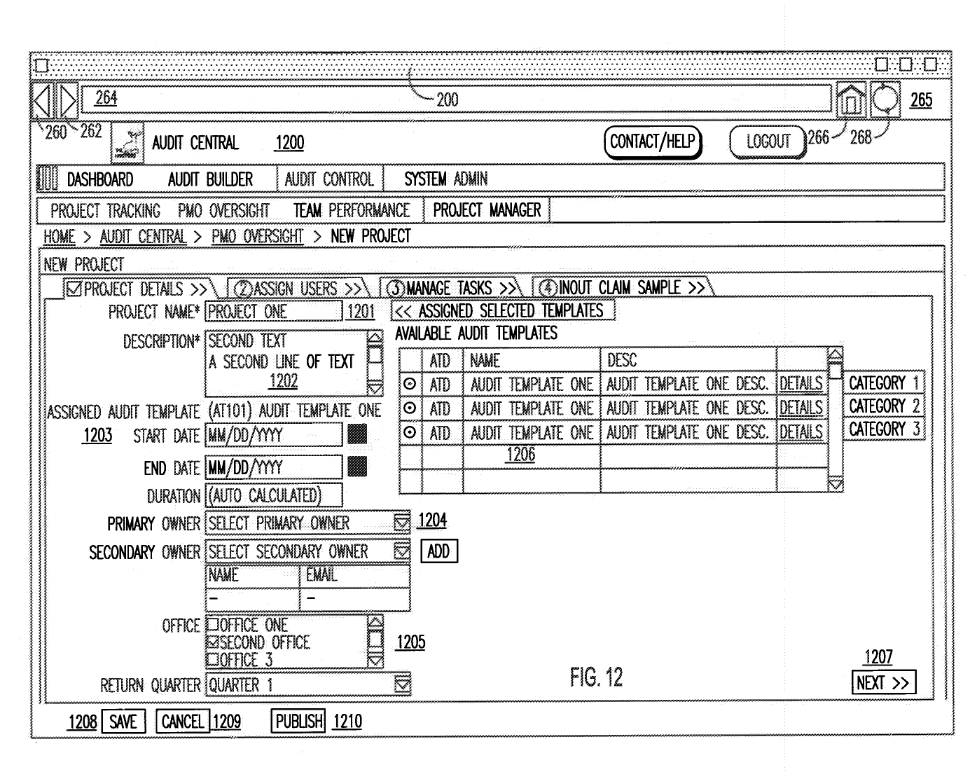

An example of a computing device that may be used for the implementation of any or any combination of these entities 123, 126, 104, and 300 is the computing device 1200 that is described below with reference to FIG. 12. Alternatively or additionally, the user device 110 may be implemented using a computing device such as the computing device 1200 of FIG. 12 and/or the cellular phone 1300 described below with reference to 13.

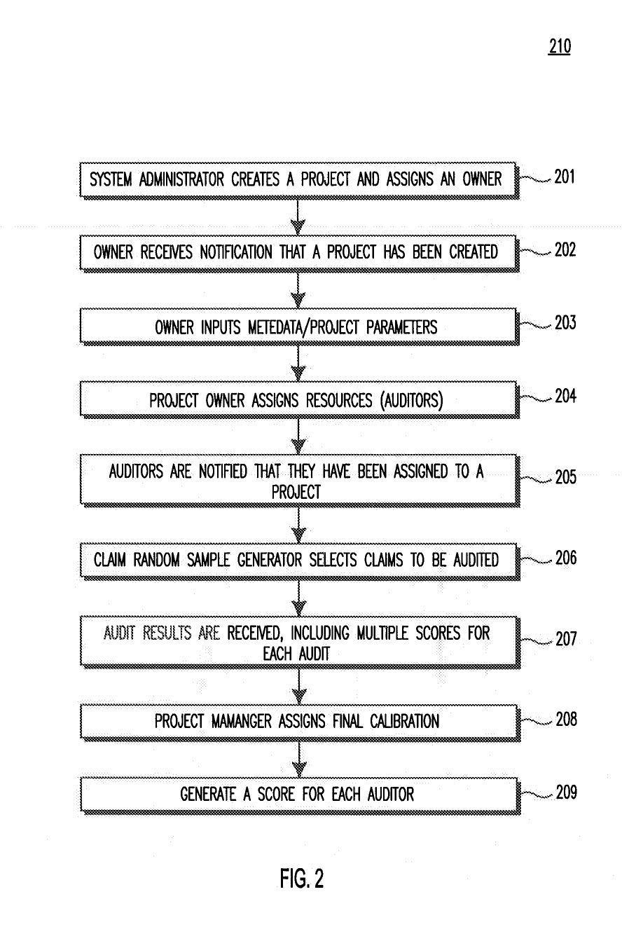

FIG. 2 shows a flow diagram of a method 210 for claims data auditing. The method allows for a centralized evaluation of claim, claims adjusters, and claim auditors. The method 210 may begin when a system administrator operating a user device, capable of communicating with the web site system 120, accesses the system administration module. The web site system 120 transmits information questions relating to the creation of a new project to the user device of the system administration. The system administrator enters information associated with creating a project and assigning an owner to the project and this information is transmitted to the web site 120 (step 201).

Once the system administration module has received information identifying a project and a project owner, the system 300 transmits a message (step 202) to the assigned project owner to notify the project owner that a project has been created. The system 300 may use any type of electronic medium to notify the project owner (e.g. email, SMS, telephone).

The project owner, operating a user device capable of communicating with the web site system 120, may access the audit central system 300. The project owner, operating the user device may log into the audit central system 300 and selects or enters the appropriate metadata (step 203) to associate to the project. The metadata may include, for example, project name, a project description, a starting and ending date for a project, secondary owners for the project etc. The project owner's selections are received by the web site system 120. The project owner, operating the user device, may also assign resources (step 204) to the project. These resources may include auditors, equipment, and any other components needed to complete the project. These selections are received by the project manager module 330.

The system 300 then transmits a notification message (step 205) to each assigned auditor, notifying them that they have been assigned to a project. When an auditor, operating a user device capable of communicating with the web site system 120 accesses the system 300, the Claim Random Sample Generator selects a set of claims to audit and provides them to the user device of the auditor (step 206).

The auditor submits to the web site, via the user device, completed audits (step 207). In order to check the quality of each audit, multiple auditors may be assigned to evaluate each claim or a subset of claims.

As each audit is completed, system 300 notifies the project owner of the submission. The project owner, operating a user device, may view each audit and provide a final calibration (step 208).

A software based algorithm receives the scores for each claim along with the calibrations entered by the project owner, and generates a report for each customer, each claim, and each auditor (step 209). The system 300 then accesses a report card template and generates a report card for each customer, claim, and auditor.

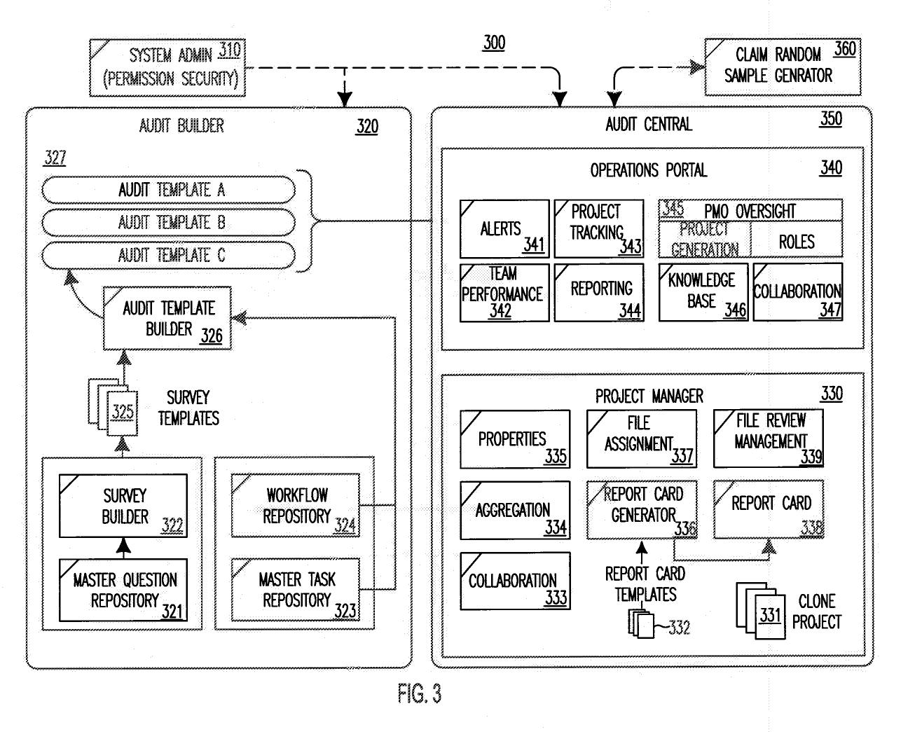

FIG. 3 shows a functional block diagram of a system 300 for automated claims data auditing. As shown in FIG. 3, the system 300 may comprise a system administration module 310, an audit builder 320, a project central module 350 and a claim random sample generator 360.

Audit Builder

The audit builder 320 is configured to allow an operator to create audit templates for use in audits for an organization. The audit builder 320 allows the operator a flexible interface to build these audits from scratch or by accessing saved questions, survey templates, workflows and tasks. The audit builder 320 may comprise a master question repository 321, a survey builder 322, a master task repository 323, a workflow repository 324, an audit template builder 326 and it may store survey templates 325 and audit templates 327. Once an audit template 327 is created, the audit builder 320 may be accessed by the project central module 350. The audit builder 320 may provide the project central module 350 with a snapshot or a copy of the selected audit template 327. This allows the flexibility of adjusting templates at a system/organizational level without affecting active audits. The audit builder 320 may also add skip logic to selected questions. The audit builder 320 may further be configured to manage version control of survey templates. In general, the audit builder may be preconfigured by the system administrator. However, as audit questions, workflows, and templates are customized, this information may be fed back to the audit builder 320.

The audit builder 320 includes a master question repository 321 that is configured to act as a central location to store the audit questions. The master question repository allows an operator to access all of the previously entered questions to quickly generate a survey template 325. An operator using a user device may enter questions into the master question repository 321. Additionally, if a new question is entered into a survey template 325 or audit template 327, audit builder 320 may update the master question repository 321. The master question repository 321 may include the following metadata fields associated with each question entry: a unique mater question repository ID; question data; response set (e.g. true or false); response set type (multi-select, single select, multi-line text, single line text, number, currency, date-time, Yes/No, person or group, lookup information already available, rating Scale); LOB; category; claim symbol; version number; create date; created by; modified date; modified by; and comments. An operator may access the master question repository 321 and add, edit, delete and view any question. The operator may also access the master question repository 321 and search, sort, and filter the questions. The master question repository 321 tracks any changes to the questions by updating the metadata.

Referring back to FIG. 3, the survey builder 322 is configured to generate surveys by associating one or many questions to create survey templates 325. A survey may be limited, for example, to a specific type of claim. For example, a survey may focus on property damage as the result of an automobile accident. A different survey may focus on personal injury claims as a result of an automobile accident. A user, operating a user device may access the survey builder 322 to create a new survey. To create a new survey, the user selects a line of business and a claim symbol to be associated with that survey. Based on those selections, the survey builder 322 provides the user with a list of questions stored in the master question repository 321 that include metadata tags that are associated with the particular line of business and claim symbol. The audit central system 300 may also have the flexibility to allow a user of a user device to enter new questions directly through the survey builder.

The survey builder 322 may transmit these new questions to the master question repository 321 which may then store the new question. A new question entered into the survey builder 322 sets the default line of business as the line of business associated to the particular survey template 325. However, an operator may access the survey template and modify the line of business.

An operator accessing the survey builder 322 may be presented with available fields from the claim random sample generator 360. The operator, using the survey builder 322, may select the required metadata fields from this list, which will create placeholders in the survey template 325. These placeholders are populated by the random sample. The CRSG metadata 360 may be stored in a database in the project central 350.

Referring back to FIG. 3, the master task repository 323 is configured to act as a central container of tasks that are associated with workflows. A task may be any assignment or step in a project that might be assigned. The master task repository 323 may include the following metadata fields associated with each task entry: a unique master task repository ID; task name; task description category; user role; workflow selection; create date; created by; modified; and modified by. An operator may access the master task repository 323 and add, edit, delete and view any task. The operator may also associate a workflow to a task. The operator may also access the master task repository 323 and search, sort, and filter the tasks. Each task may be assigned timing information, which may be used to generate alerts.

Referring back to FIG. 3, the workflow repository 324 is configured to act as a central container to store generic workflows. This may assist a project owner in the administration of a project. For example, each survey template may have a default workflow associated with it. A workflow may be a collection of tasks. The workflow repository 324 allows a user to define tasks and put them in logical order and assign tasks. For example, a task might be to publish a project; this might be assigned to the project owner or auditor. The workflow repository 324 may be preconfigured with list of workflow actions (e.g., send email). The workflow repository 324 may include the following metadata fields associated with each workflow entry: a unique workflow repository ID; name; description; category; create date; created by; modified; modified by; and version number. An operator may access the workflow repository 324 and add, edit, delete and view any workflow. The operator may also access the workflow repository 324 and search, sort, and filter the workflow entries. If the operator enters in new tasks into a workflow, the audit builder 320 may be configured to store the new question in the master task repository 323.

Referring back to FIG. 3, the audit template builder 326 may be configured to create associations with survey templates 325, tasks and associated workflows. A single event may result in multiple claims; an audit template can be customized to include surveys for each claim. For example, an audit template for an auto accident may include surveys for property damage claims as well as personal injury claims. A template may be created for a specific project. The user may apply changes to the audit templates of selected open projects. However, a user cannot apply a manual change to a closed project. The system 300 may notify project owners of changes to the audit template. The audit template builder 326 may include the following metadata fields associated with each audit template: a unique audit template ID; name; MTR_ID; SURVTEMP_ID; survey template selection; task selection; description; category; task predecessor; milestone indicator; start date; end date; version; create date; created by; modified; and modified by. An operator may access the workflow repository 324 and add, edit, delete and view any workflow. The operator may also associate survey templates with an audit template. The operator may also associate tasks with each template. The operator may also access the workflow repository 324 and search, sort, and filter the audit templates. Once an audit template 327 is created in the audit builder 320 it may be accessed for different projects. A project owner wanting to use an audit template 327 receives a snapshot or a copy of the audit template 327.

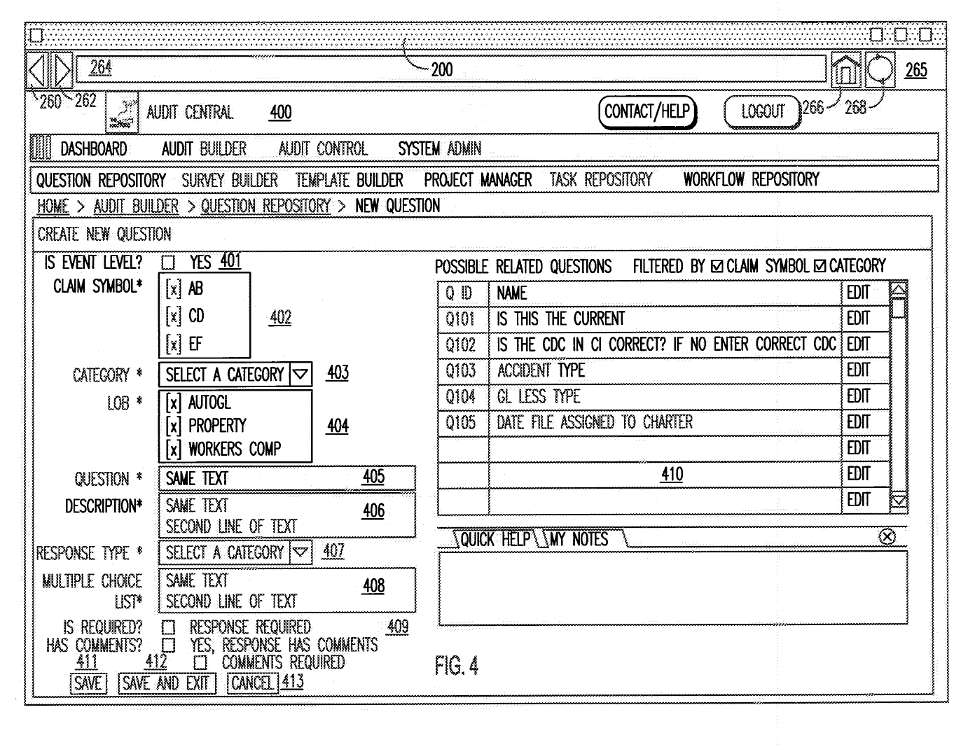

FIGS. 4-14B show example web pages that may be displayed by the web browser module 112. As will be described in detail below, the web pages may include display elements which prompt the user of the client device 110 for auditing information, such as questions, tasks, and workflows to generate an Audit Template 327. The web pages may be included in a web browser window 200 that is displayed and managed by the web browser module 112. The web pages may include data received by the web browser module 112 from the web site system 120.

Referring to FIGS. 4-14B, the web browser window 200 may include a control area 265 that includes a back button 260, forward button 262, address field 264, home button 266, and refresh button 268. The control area 265 may also include one or more additional control elements (not depicted). The user of the client device 110 may select the control elements 260, 262, 264, 266, 268 in the control area 265. The selection may be performed, for example, by the user clicking a mouse or providing input via keyboard, touch screen, and/or other type of input device. When one of the elements 260, 262, 264, 266, 268 is selected, the web browser module 112 may perform an action that corresponds to the selected element. For example, when the refresh button 268 is selected, the web browser module 112 may refresh the page currently viewed in the web browser window 200.

FIG. 4 shows example web page 400 that may be displayed by the web browser module 112 to provide a user with access to the master question repository 321. The web page includes display elements which prompt the user for audit questions for the master question repository 321. The user may enter responses in input areas 401-410. As described above, a user may update the master question repository by entering new audit questions. If the question is an event level question, the user may appropriately respond in input area 401. Input area 402 allows a user to select one or more claim symbols to be associated with the question. Input areas 403 and 404 receive information concerning the category and line of business associated with the question. The user may submit a new audit question in input area 405 using a user device 110. The web browser module may also solicit additional information about the audit question in input areas 407-409, such as a description, a response type, multiple choice selections (if applicable), whether the question is required, whether a comments field will be provided. As the user provides input into the input fields, the web browser module 112 may store one or more data structures (“response data”) that reflect the data entered into in the input fields. Further, as the data is entered, the web browser module 112 may update the audit question area to indicate additional or more specific questions or to remove non-relevant questions, for example, as shown in FIG. 4, a list of related questions are presented to the user in input area 410. This allows the user to determine whether the new question is covered by a previously stored question the user may also access these questions and edit previously stored questions rather than create a new question. Once the user has selected the questions to be entered into the survey, the user may select save 411 or save and exit 412 and the master question repository 321 stores the questions, which are accessible by the survey builder 322 to generate survey templates 325. The user may also select cancel 413, which cancels the generation of the new question.

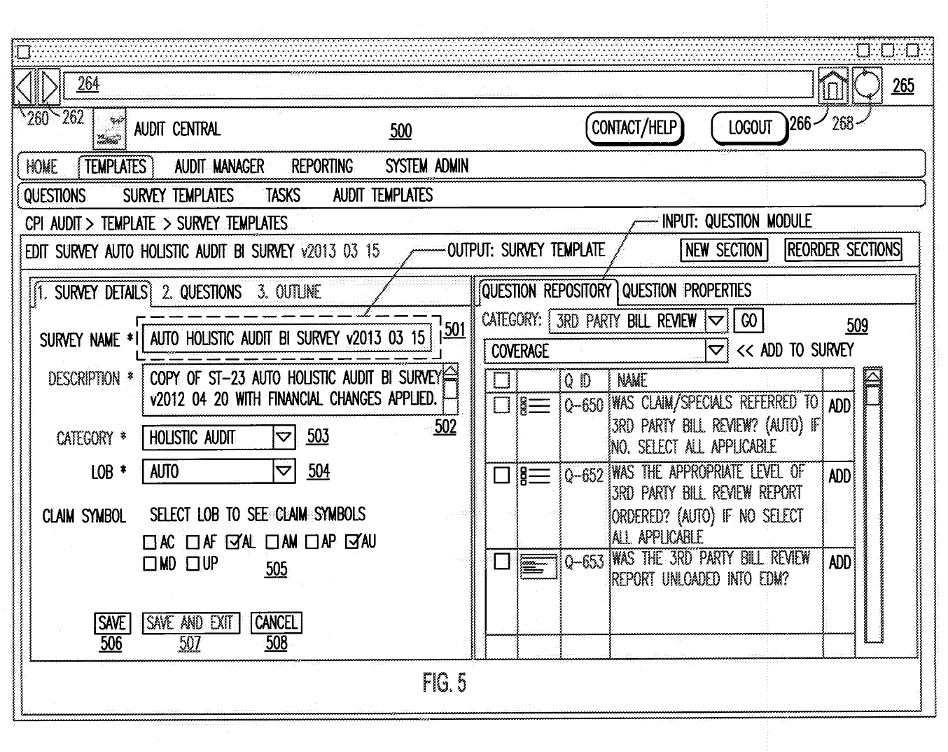

FIG. 5 shows example web page 500 that may be displayed by the web browser module 112 to provide a user with access to the survey builder 322. The web page includes display elements which prompt the user for survey questions for creating/editing survey templates 325. The web browser module 112 may receive input in input area 501 that creates a name for the survey. The name selected in input area 501 will be the name of the survey template 325 the output by the survey builder 322. Input area 502 is provided to allow the user to enter a description of the survey template 325. Input area 503 is provided to allow the user to enter a category for the survey (e.g. holistic audit). Input area 504 is provided to allow the user to select a line of business for the survey. Based on the selection of the line of business, input area 505 may present a set of claim symbols to the user, which may be selected. If no claim symbols are selected, the survey builder 322 may be configured to treat the survey as an event survey. The survey builder 322 may identify metadata associated with the received inputs from input areas 501-505 and implement a software based algorithm to select questions from the master question repository 321. As the user provides input into the input fields, the web browser module 112 may store one or more data structures (“response data”) that reflect the data entered into in the input fields. Further, as the data is entered, the web browser module 112 may update the web page to indicate additional or more specific questions or to remove non-relevant questions. The questions from the master question repository 321 are presented in input area 509. The user may select questions in input area 509 for inclusion in a survey template. Once the user has selected the questions to be entered into the survey, the user may select save 506 or save and exit 507 and the survey builder generates 322 survey templates 325. The user may also select cancel 508, which cancels the generation of a survey template 325.

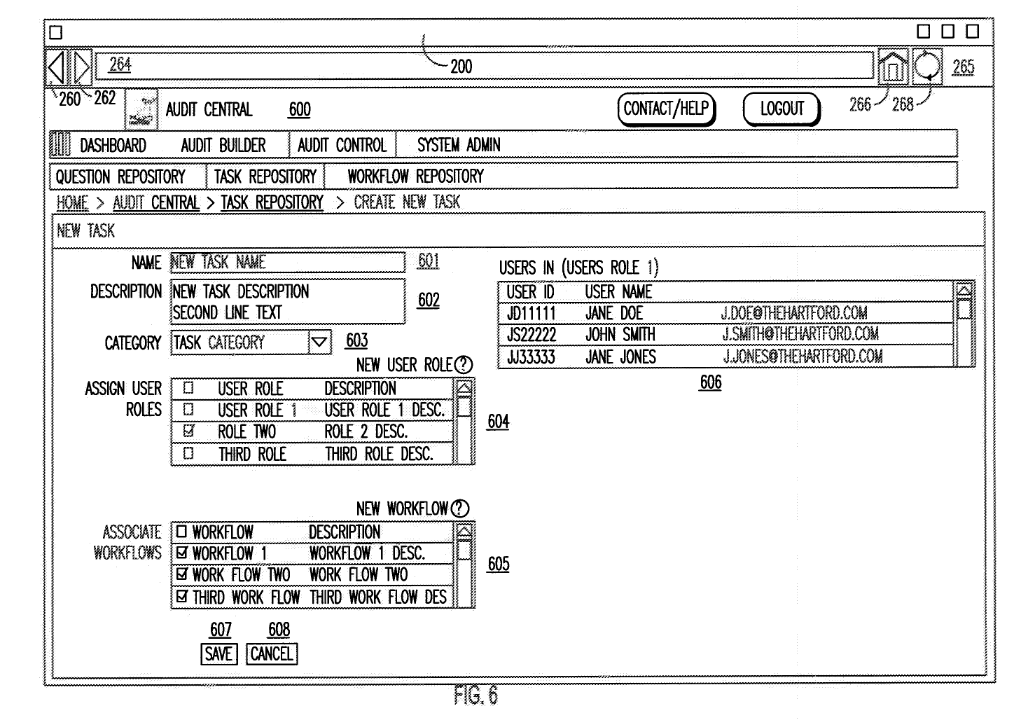

FIG. 6 shows example web page 600 that may be displayed by the web browser module 112 to provide a user with access to the master task repository 323. The web page includes display elements which prompt the user for survey questions for creating and storing tasks in the master task repository 323. The web browser module 112 may receive input in input area 501 that creates a name for the task. Input area 602 is provided to receive description information about the task. Input area 603 is shown as a drop down menu, allowing the user to select a task category. Input area 604 is provided to assign tasks to user roles. When a project is eventually created with users assigned to the roles, these tasks may then be automatically assigned. Input area 605 is provided to associate a task with a workflow. In some embodiments, input area 606 may be included to allow selection of actual users for each user role. As the user provides input into the input fields, the web browser module 112 may store one or more data structures (“response data”) that reflect the data entered into in the input fields. Further, as the data is entered, the web browser module 112 may update the web page to indicate additional or more specific questions or to remove non-relevant questions. Once the user has entered the information, the user may select save 607 and the master task repository 323 stores the tasks, which are accessible by the workflow repository 324 and the audit template builder 326 to create workflows and audit templates 327. The user may also select cancel 608, which cancels the generation of the new task.

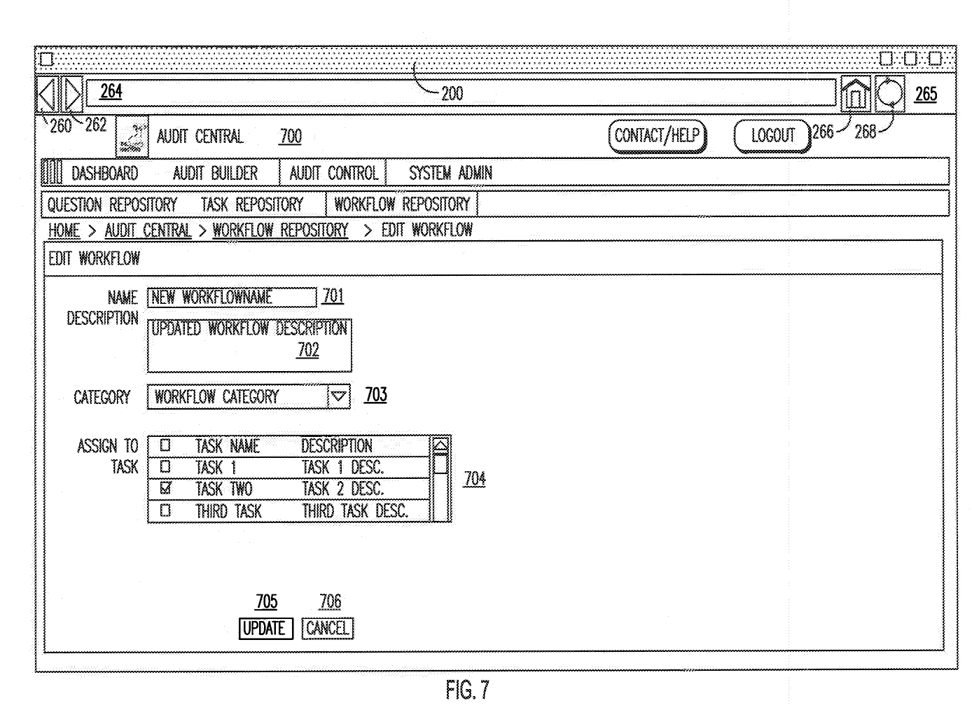

FIG. 7 shows example web page 700 that may be displayed by the web browser module 112 to provide a user with access to the workflow repository 324. The web page includes display elements which prompt the user for creating new workflows. As shown in FIG. 7, the workflow may be a combination of tasks. Input area 701 is provided to enter a name for the workflow. Input area 703 is shown as a drop down menu, allowing the user to select the workflow category. Input area 704 is provided to select tasks. The web browser module 112 allows the user to reorder the tasks and to assign the tasks using input area 704. The user may enter a work flow, description, and category and also assign tasks. As the user provides input into the input fields, the web browser module 112 may store one or more data structures (“response data”) that reflect the data entered into in the input fields. Further, as the data is entered, the web browser module 112 may update the web page to indicate additional or more specific questions or to remove non-relevant questions. Once the user has entered the information, the user may select the update button 705 which will store data in the workflow repository 324. The user may also select cancel 706, which cancels the generation of the new workflow.

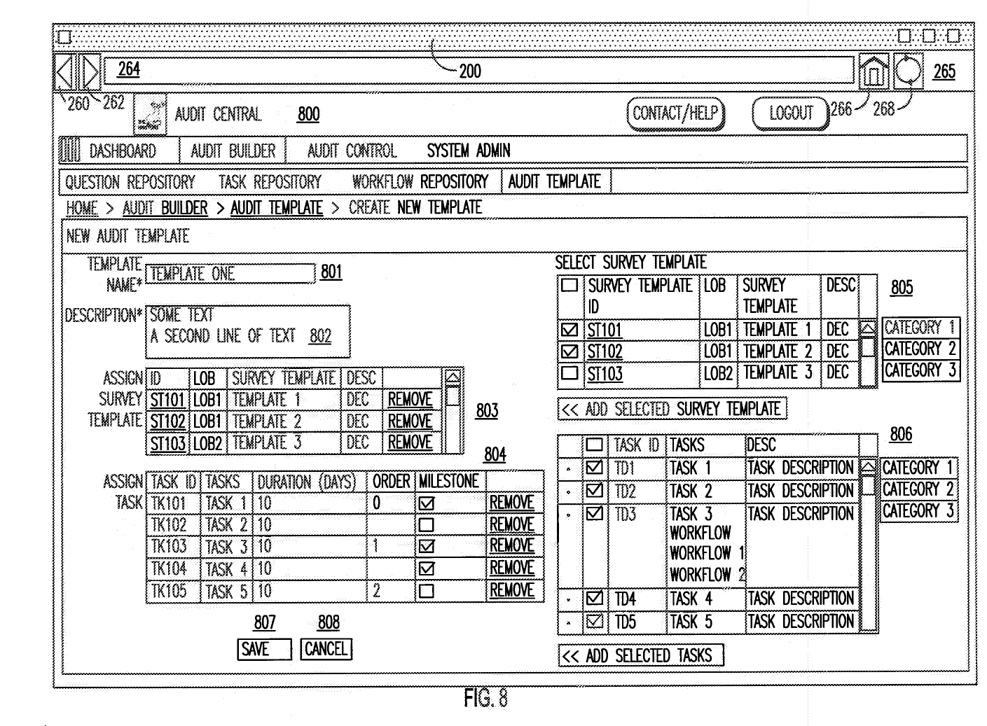

FIG. 8 shows example web page 800 that may be displayed by the web browser module 112 to provide a user with access to the audit template builder 326. The web page includes display elements which prompt the user for creating audit templates 327. Input area 801 is provided to solicit a template file name. The data input into input area 801 is used to create a template name for the output file of the audit template builder 326. Input area 805 allows a user to select survey templates 325 to associate with the audit template. Input area 803 also allows the user to assign user roles to the selected survey templates. Input area 806 allows the user to select tasks from the master task repository 323 to associate with the audit template. Input area 804 allows the user to assign those selected tasks to different user roles. The user is also prompted to provide a description of the particular template. The user may select survey templates 325 to be inserted into the audit template 327 in input area 802. As the user provides input into the input fields, the web browser module 112 may store one or more data structures (“response data”) that reflect the data entered into in the input fields. Further, as the data is entered, the web browser module 112 may update the web page to indicate additional or more specific questions or to remove non-relevant questions. Once the user has selected templates and tasks, the user may select save 807 and the audit template builder 326 may generate an audit template 327. The user may also select cancel 808, which cancels the generation of the new audit.

System Administration Module

Referring back to FIG. 3, the system administration module 310 handles permissions and security for the system 300. The system administration module 310 may be used to manage application security be generating defined user groups. The system administration module 310 may authorize/permit user groups or users different access levels to the system 300. A system administrator may access the system administration module 310 and assign user roles to each individual that is permitted to access the system 300. A user role may be a defined job with a collection of users assigned to features. The system administration module 310 may be used to add/edit and delete these user roles. The system administration module 310 may be used to assign a system administrator whose role is a “super user” with access to all features. As an example, the system administration module 310 may be used to assign predefined roles, such as: system administrator, PMO administrator, project owner, auditor, and office manager.

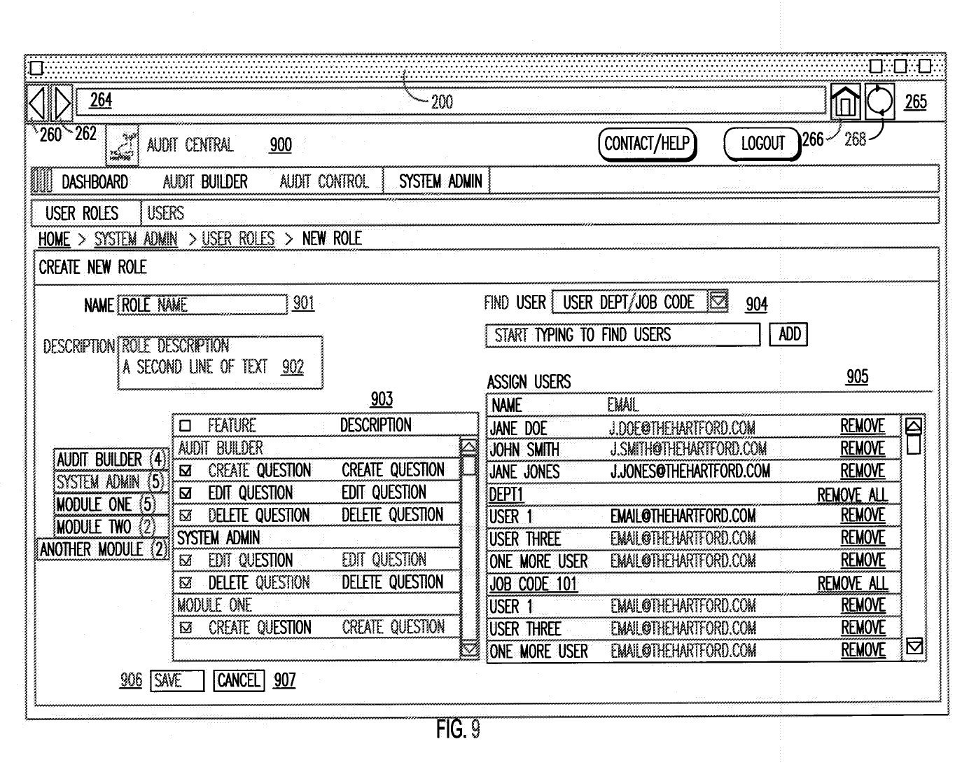

FIG. 9 shows example web page 900 that may be displayed by the web browser module 112 for providing access to the system administration module 310. The web page includes display elements which prompt the user for assignment of user roles. As shown in FIG. 9, input area 901 is provided for a system administrator to access the system administration module 310 and assign user roles. Input area 902 is provided to allow the system administrator to provide a description of each user role. Input area 903 is provided to allow a system administrator to assign features to each user role. Input areas 904 and 905 are provided to allow the system administrator to search of individuals and assign them to the newly identified user role. As the system administrator provides input into the input fields, the web browser module 112 may store one or more data structures (“response data”) that reflect the data entered into in the input fields. Further, as the data is entered, the web browser module 112 may update the web page to indicate additional or more specific questions or to remove non-relevant questions. Once the user has entered the information, the data is stored by the system admin module 310. Once the system administrator has named, defined and assigned the user role, the system administrator may select save 906 and the user role will be saved into the system 300. The user may also select cancel 907, which cancels the generation of the new user role.

Project Central Module

Referring back to FIG. 3, the project central module 350 may be configured to allow oversight of the projects in the system, including the direct management of a single project and access to individual projects. When a project is created, the project central module 350 receives a snapshot or copy of a selected audit template from the audit builder 320. Each project may be based on a single audit template 327, which may be comprised of multiple survey templates 325. Once a project is created and the copy of the audit template 327 is provided to project central module 350, users may access the copy of the template and begin work on a project. By allowing users to work on a copy of the template, the auditors to work remotely and collaborate in real-time at the same time, the audit templates 327 may be modified at a system or organization level, without affecting audits in progress. The project central module 250 may allow multiple auditors to view a single file and determine separate scores for each file. The project central module 350 may include a project manager 330 and an operations portal 340.

The operations portal 340 may be used for oversight of one or many projects managed by a PMO administrator. The operations portal 340 may comprise an alerts module 341, a team performance module 342, a project tracking module 343, a reporting module 344, a PMO oversight module 345, a knowledge base module 346, and a collaboration module 347.

The alerts module 341 may be configured to generate and post alerts and announcements. The alerts module 341 may generate broadcast alerts to all users or groups of users in a system. The alerts module may provide alerts which users subscribe to. The alerts module may provide alerts concerning system down time. Additionally, when a project is initiated, based on the workflow, the alerts module 341 may generate alerts concerning specific tasks. The alerts module 341 may be used to associate alerts to one or many projects with the option of sending emails to associated project resources. The alerts module 341 may be configured to transmit alerts via email, SMS, MMS, robo-calls, instant messaging, social media, through the collaboration module 347 or any electronic medium. The alerts module 341 may notify users when they have been assigned to a project or when a project they have been assigned to has been modified.

The project tracking module 343 may be configured to allow a central location to manage multiple scheduled projects. The project tracking module 343 uses a software based algorithm to provide a project owner real time updates of the status of each project. The project tracking module 343 may update an event, for example, if the project dates are changed, or if a user is changed.

The PMO oversight module 345 may be configured to perform global administration of project activity. The PMO oversight module 345 provides a dashboard-like snapshot to monitor an open project on a running basis. In one embodiment, the PMO oversight module 345 may include a project generation module that may be used to create, update and delete projects. The PMO oversight module 345 may be used to create projects, assign the user role and project owner to the project. The PMO oversight module 345 may be configured to generate emails based on reports generated by the PMO oversight module 345 and distribute them to a project owner. The PMO oversight module 345 may be configured to insert a start and end date for a project. The PMO oversight module 345 may generate a calendar event in response to the creation of a project. Projects may have a configurable number of owners. The PMO oversight module 345 may prevent modifications of a project, if, for example, the project status is “complete.”

Referring back to FIG. 3, the team performance module 342 may be configured to act as a repository/archive containing blind review and holistic scores for audit teams, individual auditors, and individual audits. An operator may access the team performance module 342 to review the scores and to compute the variance between the project owner's and auditor's score (i.e. blind versus holistic). The team performance module 342 allows operators the opportunity to monitor an auditors' performance.

The reporting module 344 may be configured to allow the user to view statistical reporting at the PMO level and provide a real-time status on active and inactive projects. The reporting module 344 may also be used to compare responses for questions from different projects. The reporting module 344 may also be used to query data directly.

The knowledge base module 346 is configured to serve as a document library to store versions of operational reference materials. These materials may be stored in various formats such as text documents, PDFs, web pages and other electronic formats. The project owner, when assigning tasks, may assign an auditor to read or review a manual prior to audit. The knowledge base module 346 may be configured to keep a record to store when documents are accessed.

The collaboration module 347 may be configured to interact with participating users at the PMO level. The collaboration module 347 provides online collaborative spaces for users to collaborate on a project and share information. The collaboration module 347 may be customized for each project team. The collaboration module 347 may allow users to view and edit shared documents, including audio, video and text based documents. The collaboration module 347 may provide announcements to the group. The collaboration module 347 may also include an editable project calendar. The collaboration module 347 may also include a message board, instant messaging or other forum for online discussions. It may also include general feedback surveys.

The project manager module 330 may be configured to perform administration of a single project. The project manager module 330 may allow the project owner to assign resources to the user roles, tasks, and workflows associated with the project. In one embodiment, the project manager module 330 allows the project owner to add unique tasks to a project even if they are not included in the audit template 327. The project manager module 330 may manage survey assignment to auditors. The project manager module 330 may associate one or more survey templates 325 to each auditor. In one embodiment, this may streamline the number of questions presented to an auditor. The project manager module 330 may further be configured to mark a survey as a common survey (e.g. medical management review). This survey may be edited by auditors assigned to this survey. Other auditors may access the survey via a read-only reference view. If the project manager module 330 determines that no specific surveys are assigned to an auditor, the project manager module 330 may be configured to assign all questions in all surveys to that auditor as a default (based on claim symbol and claim combinations). The project manager module 330 may provide that auditor with a read-only reference view for the common surveys. The project manager module 330 may assign non-common surveys to an auditor and allow them to see only questions from those surveys. The project manager module 330 may confirm, when a project is published, that no associated surveys are offline, at least one claim/event is assigned, and at least one user is assigned to the auditor role.

The properties module 335 may be configured for project creation. The properties module 225 may be used to assign/adjust a project owner and user roles for each user with access. The properties module 335 may also be used to select an audit template(s).

The file assignment module 337 may be configured to allow the project owner to assign events/claims to auditors. Once an auditor has been assigned an event/claim, project central 350 may be configured to send assignment notifications to the auditors. The auditors, operating a user device, may view their assignments from the assignment queue.

The file review module 339 is configured to enable auditors to complete surveys for the events assigned to them. The auditors, using a user device, may save the responses and submit completed surveys to the file review module 339. The file review module 339 may allow the project owner to review the responses from each auditor and perform a calibration and submit the final score. The file review module 339 may be configured to create an action item queue for the project owner to review. The project owner, operating a user device, may provide a holistic score once the blind reviews are completed.

The aggregation module 334 may be configured to provide a real-time view of the summary level holistic scores for surveys captured in a project. The aggregation module 334 provides a status of the current state of a single project. The aggregation module 334 may be used to generate summary level reporting and to provide the project owner with the capability to add a narration to support the audit's findings.

The report card generator 336 may be configured to select from preconfigured report card templates 332. When a user selects a report card template 332 the report card generator selects the report card format. The report card generator 336 may access information from the other modules in the project manager 330 and output a report card 338, for example in an HTML or PDF format.

The collaboration module 333 provides a social media type platform allowing application users to store documents in central repositories and communicate with one another. The collaboration module 333 may be configured to provide discussion threads, direct messaging and user alerts.

The clone project module 331 allows a user to copy an existing project and to use it as a template for another unique project. This allows a project owner to quickly create an auditing project without having to reselect a template.

The claim random sample generator (CRSG) generates access a database containing previously filed and reviewed claims. Each claim stored in the database may have metadata associated with it. Based on the request received by the CRSG, the CRSG selects a list of claims based on the metadata associated with those claims for quality reviews and other auditing features. The CSRG is the subject of U.S. patent application Ser. No. 12/132,891 titled COMPUTER SYSTEM FOR GENERATING RANDOM SAMPLE IN RESPONSE TO SEARCH QUERY, which shares an assignee with the present application, and is incorporated by reference in its entirety. This CRSG interfaces with the file assignment module 337 to provide a random sample of claims/events to audit. For example, a project owner may create a series of projects for an entire year using the project manager module 330. This project may include start dates, end dates and cutoff dates. These projects may further be assigned resources. When the start date approaches, the project manager module 330 may be configured to contact the claim random sample generator 360. Based on the specifications of the project, the claim random sample generator 360 determines random sets of claims matching the metadata criteria communicated by the project manager module 330. The random set of claims is copied and questions are selected from the sets of claims and provided to the proper auditors.

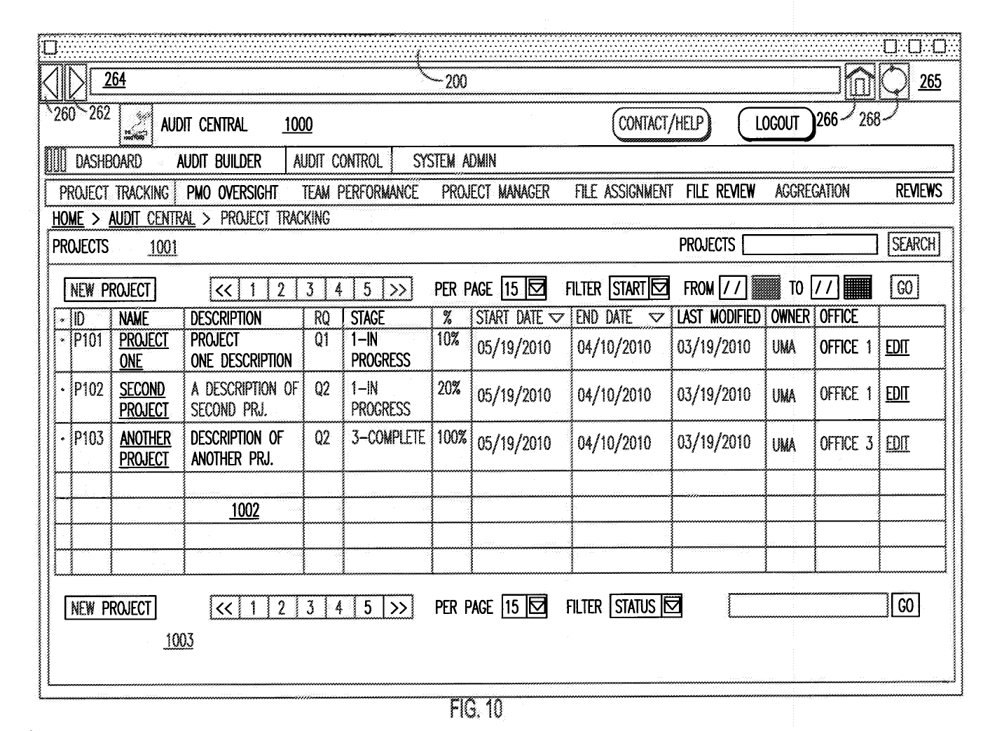

FIG. 10 shows example web page 1000 that may be displayed by the web browser module 112 for accessing the project tracking module 343. The web page includes display elements for project tracking. Web page 1000 includes input areas 1001 and 1003, which allows the user to search for projects to view or to create a new project. In the example web page of FIG. 10, there are three projects being tracked. From a central location, a user may determine the status of each project. Input area 1002 provides real times status updates as to the progress of each project, and, depending on the user role, a user may view, edit, or update each project. As the user provides input into the input fields, the web browser module 112 may store one or more data structures (“response data”) that reflect the data entered into in the input fields. Further, as the data is entered, the web browser module 112 may update the web page.

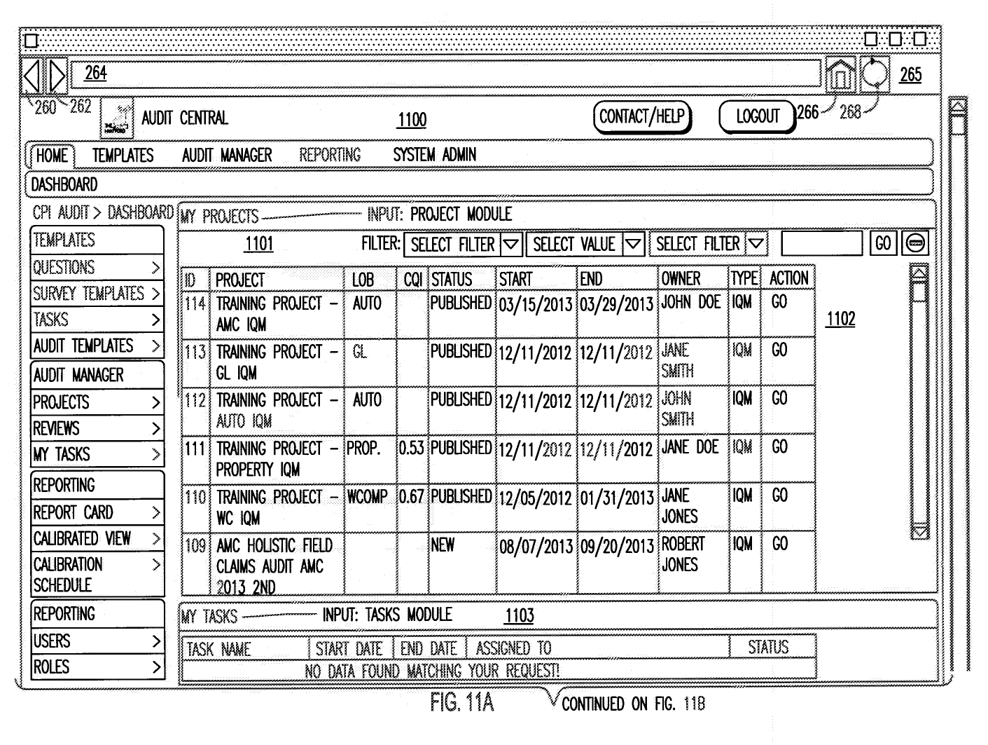

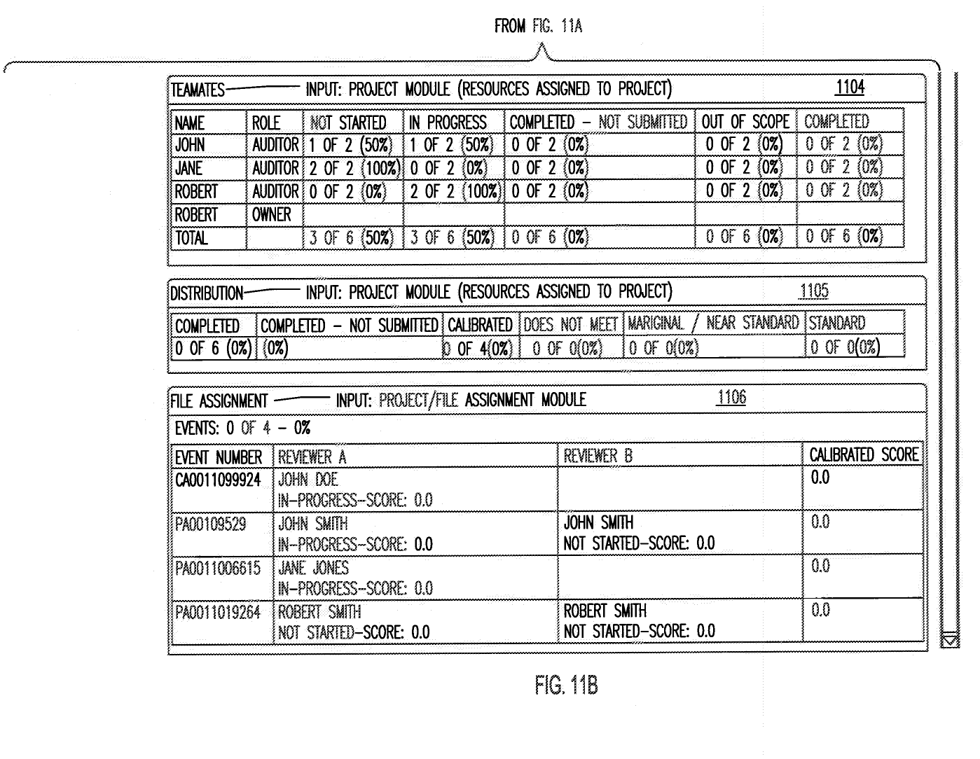

FIGS. 11A and 11B show an example web page 1100 that may be displayed by the web browser module 112 to provide access to the project tracking module 343. The project tracking module 343 may receive inputs from the various modules of the project manager 330 to provide real time updates of a project. Input area 1101 is provided to allow a user to select various filters to view different data aspects of one or more project. Input area 1103 accesses task information stored in the system 300 to provide a real time update on individual tasks. Display area 1104 provides real time information and status updates on the progress of individual teammates assigned to the project. Display areas 1105 and 1106 provide project level status information. As the data is entered into the system, the web browser module 112 may update the web page to indicate additional or more specific questions or to remove non-relevant questions. The project tracking module 343 may also output the information to an electronic medium, such as an email, PDF, or text document.

FIG. 12 shows example web page 1200 that may be displayed by the web browser module 112 to provide access to the PMO oversight module 345. The web page includes display elements which prompt the user for creating a new project. Input area 1201 is provided to allow a user to enter a name for a new project. Input area 1202 is provided to allow the user to enter a text based description of the project. Input area 1203 is provided to allow the user to select a start date, end date for the project. Input area 1204 is provided to allow the user to select a primary project owner and any secondary owner(s). Input area 1205 is provided to allow the user to identify the primary office of the primary project owner. Input area 1206 provides the project owner with the ability to select an audit template 327 generated by the audit builder 320. Input area 1206 may be adjusted based on the data provided in input areas 1201-1205. As the user provides input into the input fields, the web browser module 112 may store one or more data structures (“response data”) that reflect the data entered into in the input fields. Further, as the data is entered, the web browser module 112 may update the web page to indicate additional or more specific questions or to remove non-relevant questions. Once the user has entered the information, a project is created and the project owner is notified. Once the user has entered the information, the user may select the next button 1207. This may prompt the web browser module 112 to refresh the web page 1200 and provide additional questions to the user. The user may assign resources to the project and manage tasks. The user may then import claim samples into the project, for example, by accessing the CSRG module 360, which provides selected claims along with the associated metadata. The user may then select save 1208 and the project will be saved into the system 300. The user may select publish 1210 which will publish the project, making it available to view by the assigned resources. Selecting publish 1210 may also activate the alerts module 341 to notify the resources that a new project has been published. The user may also select cancel 1209, which cancels the generation of the new project.

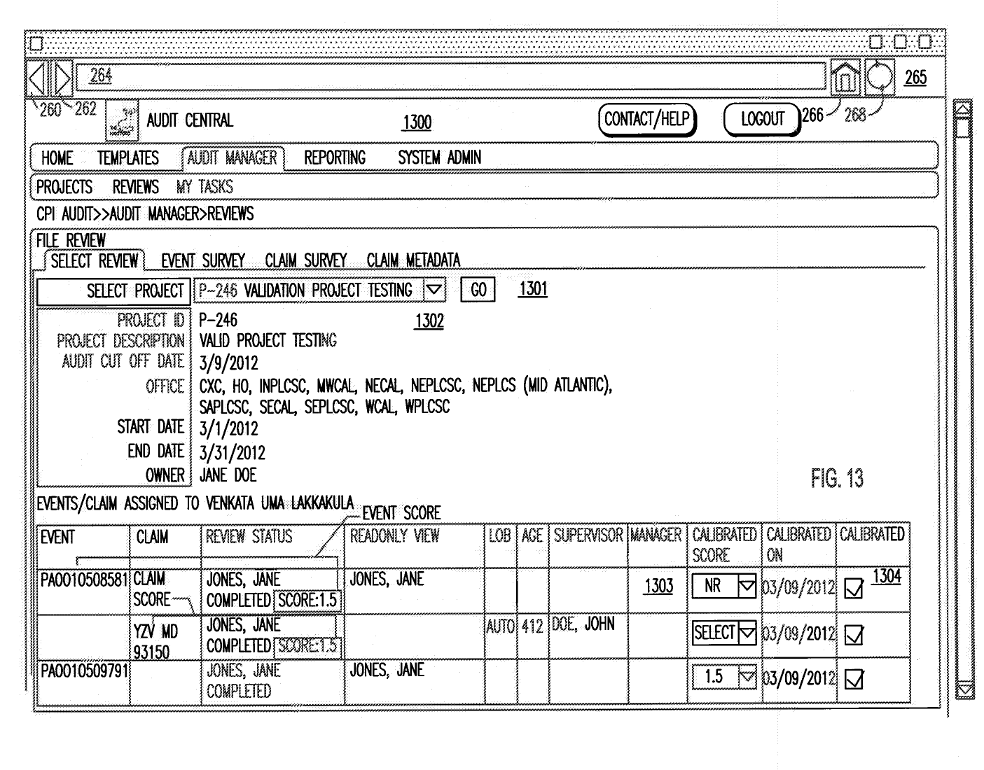

FIG. 13 shows example web page 1300 that may be displayed by the web browser module 112 to provide access to file review module 339. Input area 1301 is provided, which allows the user to select a project for review. Display area 1302 accesses the system 300 and provides information for predetermine fields, for example: project identification, project description, audit cutoff date, office, start date, end date, and project owner. Display area 1303 allows the project owner to see the scores and progress by each auditor. Input area 1304 allows the project owner to calibrate each of the scores to generate a final score for each audit. As the user provides input into the input fields, the web browser module 112 may store one or more data structures (“response data”) that reflect the data entered into in the input fields. Further, as the data is entered, the web browser module 112 may update the web page to indicate additional or more specific questions or to remove non-relevant questions. The results from the file review module 339 may not only provide scoring information for each audit, but may be used to generate information concerning each auditor as well.

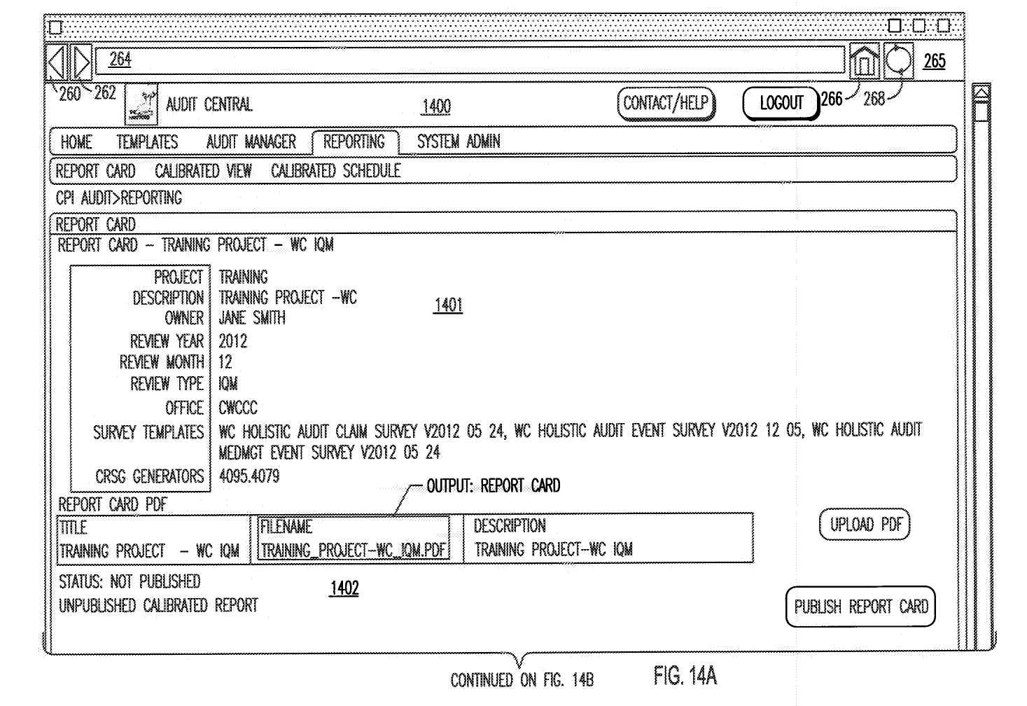

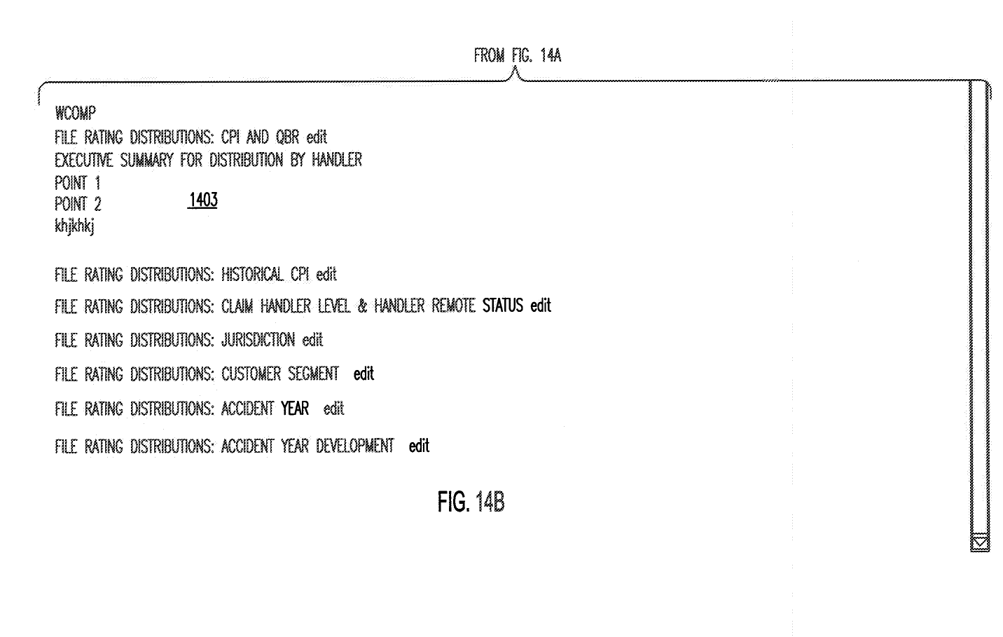

FIGS. 14A and 14B show an example web page 1400 that may be displayed by the web browser module 112 to provide access to the report card generator 336. A report card, 338, may be the final output of a project. A report card may receive inputs from multiple modules. The report card generator 336 uses a software based algorithm to determine a report, a summary of which is displayed in display area 1401. The report card generator 336 may present a user with input area 1403 allowing the project owner to select the fields to include on a report card 338. As the user provides input into the input fields, the web browser module 112 may store one or more data structures (“response data”) that reflect the data entered into in the input fields. Further, as the data is entered, the web browser module 112 may update the web page to indicate additional or more specific questions or to remove non-relevant questions. Input area 1402 allows the user to determine the output format of the report card, the report card 338 generated may be output in any number of electronic formats for review. Input area 1402 is provided to allow a project owner to determine whether to publish the report card, by selecting the publish report card button presented on the by the web browser module 112.

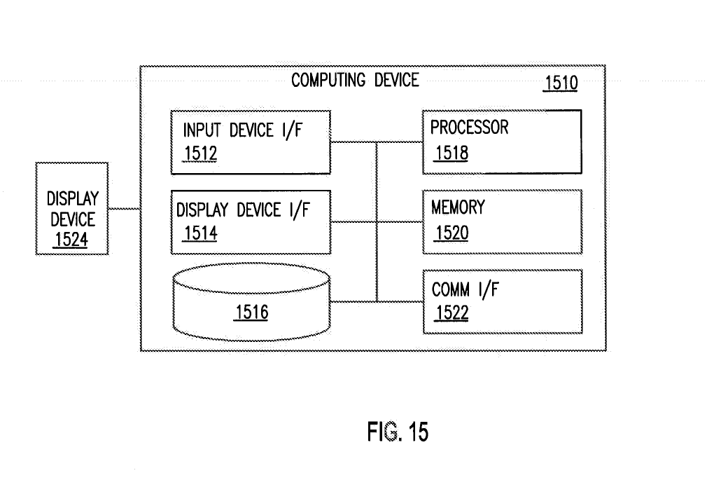

FIG. 15 shows an example computing device 1510 that may be used to implement features describe above with reference to FIGS. 1-14B. The computing device 1510 may include a processor 1518, memory device 1520, communication interface 1522, input device interface 1512, display device interface 1514, and storage device 1516. FIG. 15 also shows a display device 1524, which may be coupled to or included within the computing device 1510.

The memory device 1520 may be or include a device such as a Dynamic Random Access Memory (D-RAM), Static RAM (S-RAM), or other RAM or a flash memory. The storage device 1516 may be or include a hard disk, a magneto-optical medium, an optical medium such as a CD-ROM, a digital versatile disk (DVDs), or Blu-Ray disc (BD), or other type of device for electronic data storage.

The communication interface 1522 may be, for example, a communications port, a wired transceiver, a wireless transceiver, and/or a network card. The communication interface 1522 may be capable of communicating using technologies such as Ethernet, fiber optics, microwave, xDSL (Digital Subscriber Line), Wireless Local Area Network (WLAN) technology, wireless cellular technology, and/or any other appropriate technology.

The input device interface 1512 may be an interface configured to receive input from an input device such as a keyboard, a mouse, a trackball, a touch screen, a touch pad, a stylus pad, and/or other device. The input device interface 1512 may operate using a technology such as Universal Serial Bus (USB), PS/2, Bluetooth, infrared, and/or other appropriate technology.

The display device interface 1514 may be an interface configured to communicate data to display device 1524. The display device 1524 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 1514 may operate using technology such as Video Graphics Array (VGA), Super VGA (S-VGA), Digital Visual Interface (DVI), High-Definition Multimedia Interface (HDMI), or other appropriate technology. The display device interface 1514 may communicate display data from the processor 1218 to the display device 1524 for display by the display device 1524. As shown in FIG. 15, the display device 1524 may be external to the computing device 1510, and coupled to the computing device 1510 via the display device interface 1514. Alternatively, the display device 1524 may be included in the computing device 1500.

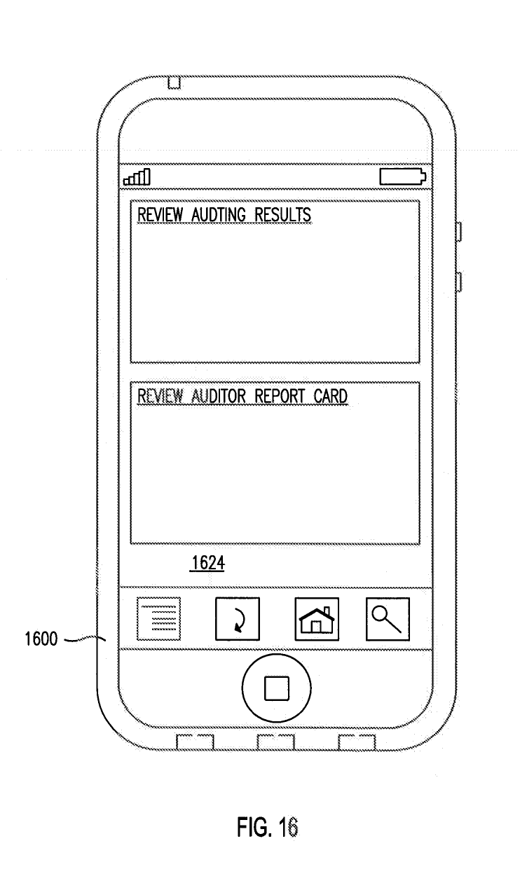

An instance of the computing device 1510 of FIG. 15 may be configured to perform any feature or any combination of features described above as performed by the user device 110. In such an instance, the memory device 1520 and/or the storage device 1516 may store instructions which, when executed by the processor 1518, cause the processor 1518 to perform any feature or any combination of features described above as performed by the web browser module 112. In such an instance, the computing device 1510 may be, for example, a laptop computer, a tablet computer, a desktop computer, cellular phone (such as but not limited to the cellular phone 1600 described below with reference to FIG. 16), a personal digital assistant (PDA), or any other appropriate computing device.

Alternatively or additionally, an instance of the computing device 1510 may be configured to perform any feature or any combination of features described above as performed by the HTTP server module 123, CMS 126, and/or audit central system 300. In such an instance, the memory device 1520 and/or the storage device 1516 may store instructions which, when executed by the processor 1518, cause the processor 1518 to perform any feature or any combination of features described above as performed by the HTTP server module 123, CMS 126, and/or the audit central system 300. In such an instance, the computing device 1510 may be a server computer or any other appropriate computing device.

Further, an instance of the computing device 1510 may be configured to perform any features or combination of features described above as performed by the policy management system 104. In such an instance, the memory device 1520 and/or the storage device 1516 may store instructions which, when executed by the processor 1518, cause the processor 1518 to perform any feature or any combination of features described above as performed by the policy management system 104. In such an instance, the computing device 1510 may be a server computer or any other appropriate computing device.

FIG. 16 shows a cellular phone 1600 that is a more specific example of the computing device 1500 described above with reference to FIG. 15. The cellular phone may include a touch screen 1624, and may also include a processor (not depicted), memory device (not depicted), communication interface (not depicted), input device interface (not depicted), display device interface (not depicted), and storage device (not depicted), which may possess characteristics of processor 1518, memory device 1520, communication interface 1522, input device interface 1512, display device interface 1514, and storage device 1516 described above with reference to FIG. 15. The touch screen 1624 is a more specific example of the display device 1524 described above with reference to FIG. 15, and may be based on technology such as, for example, LCD, LED, and/or other appropriate display technology. The touch screen 1624 may receive user input using technology such as, for example, resistive sensing technology, capacitive sensing technology, optical sensing technology, or any other appropriate touch-sensing technology. The touch screen 1624 may provide user input data to the input device interface (not depicted) in the cellular phone 1600. The communication interface (not depicted) in the cellular phone may be a wireless transceiver, and may be capable of communicating using wireless technology such as Long Term Evolution (LTE), LTE-Advanced (LTE-A), Universal Mobile Telecommunications System (UMTS), IEEE Institute of Electrical and Electronics Engineers (IEEE) 802.16/WiMax, IEEE 802.16m, Wireless Broadband (WiBro), Global System for Mobile Communications (GSM), Enhanced Data Rates for GSM Evolution (EDGE) Radio Access Network (GERAN), Code Division Multiple Access 2000 (CDMA2000), and/or any other appropriate wireless technology.

The touch screen 1624, as shown in FIG. 16, may display input and output areas similar to the features of the web pages described in FIGS. 4-14B above. As described above with reference to FIG. 15, the processor in the cellular phone 1500 may execute instructions which cause the processor to perform the functionality described above as performed by the web browser module 112. This may include displaying the display elements in the touch screen 1624, as shown in FIG. 16. These display elements may display similar data and receive user input in a similar fashion as that described above with respect to the corresponding display elements of FIGS. 4-14B. A user of the cell phone 1600 may interface with these display elements by using the touch screen 1624.

Although examples are provided above with reference to FIGS. 1-16 wherein data is communicated between a web site system 120 and a web browser module 122, the features described above as performed by the web site system 120 and/or the web browser module 122 may be implemented in any combination of software and/or hardware. For example, the features described above as performed by the web browser module 122 and/or the web site system 120 may be performed, mutatis mutandis, by one or more dedicated or special-purpose applications.

Although examples are provided above with respect to selected insurance related to businesses, business owners, and business insurance product, the features describe above with reference to FIGS. 1-16 are equally applicable, mutatis mutandis, to other contexts. For example, the features described above may be used for the communication of information related to and/or the selection of insurance products that are applicable to all types of insurance consumers, including individuals, businesses, non-profit entities, governmental entities, and/or any other types of insurance consumers. For example, the features described above may be used for communication of information related to and/or the selection of individual insurance products, and/or any other insurance products. Alternatively or additionally, the features described above may be used for the communication of information related to and/or the selection of financial products that are not insurance products, such as risk management services, bonds, retirement plans, savings plans, and/or group benefits plans.

When referred to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other device for electronic data storage.

As used herein, the term “processor” broadly refers to and is not limited to a single- or multi-core general purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Although features and elements are described above in particular combinations, each feature or element can be used alone or in any combination with the other features and elements. For example, each feature or element described above with reference to any one or any combination of FIGS. 1-16 may be used alone without the other features and elements or in various combinations with or without other features and elements described above with reference to any one or any combination of FIGS. 1-16. Sub-elements of the methods and features described above may be performed in any arbitrary order (including concurrently), in any combination or sub-combination.

What is claimed is:

1. A system for automated claims data auditing, the system comprising:
a memory device configured to store a plurality of audit questions associated with audit question metadata, to store a plurality tasks associated with task metadata, to store a plurality workflows associated with workflow metadata and to store a plurality surveys associated with survey metadata;
a processor configured to generate an audit template based on at least a subset of the plurality of surveys and the plurality of tasks;
the processor further configured to generate a copy of the audit template for use in a project;
a receiver configured to receive assignment instructions associated with the project, wherein the assignment instruction assign resources to the project;
the receiver further configured to receive claim data to be audited, wherein the processor is configured to integrate the received claim data, the copy of the audit template, and the assignment instructions to create the project; and
a publishing module configured to publish the project.

2. The system of claim 1 further comprising a transmitter to transmit alerts to a plurality of user devices in response to publishing the project.

3. The system of claim 1, wherein the memory device is configured to store user roles, wherein each user role may have different levels of access to documents in the system.

4. The system of claim 3, wherein at least one user role is a system administrator.

5. The system of claim 1, wherein the memory device only permits a system administrator to modify an audit template.

6. The system of claim 1 further comprising a claim random sample generator configured to generate the claim data to be audited.

7. The system of claim 6, wherein the claim random sample generator selects the claim data to be audited based on at least one of the audit question metadata, task metadata, workflow metadata, or survey metadata.

8. The system of claim 1, wherein the receiver is configured to receive a plurality of completed audits from a plurality of user devices.

9. The system of claim 8, wherein the processor is configured to generate a report card based on the plurality of completed audits.

10. A computer based method for automated claims data auditing, the method comprising:
storing, in a memory device a plurality of audit questions associated with audit question metadata, a plurality tasks associated with task metadata, a plurality workflows associated with workflow metadata and a plurality surveys associated with survey metadata;
generating, by a processor, an audit template based on at least a subset of the plurality of surveys and the plurality of tasks;
generating, by the processor, a digital copy of the audit template for use in a project;
receiving, by a receiver, assignment instructions associated with the project, wherein the assignment instruction assign resources to the project;
receiving, by the receiver, claim data to be audited;
integrating, by the processor, the received claim data, the copy of the audit template, and the assignment instructions to create the project; and
publishing the project.

11. The method of claim 10 further comprising transmitting alerts to a plurality of user devices in response to publishing the project.

12. The method of claim 10, further comprising storing user roles, wherein each user role may have different levels of access to documents in the system.

13. The method of claim 12, wherein at least one user role is a system administrator.

14. The method of claim 10, preventing, by the memory device, modifications to the audit template based on a determined user role.

15. The method of claim 10 further comprising selecting, by a claim random sample generator, the claim data to be audited.

16. The method of claim 15, wherein the selecting the claim data is based on at least one of the audit question metadata, task metadata, workflow metadata, or survey metadata.

17. The method of claim 10, further comprising receiving a plurality of completed audits from a plurality of user devices.

18. The method of claim 17, further comprising generating a report card based on the plurality of completed audits.
